(19) United States
(12) Patent Application Publication
(10) Pub. No.: US 2011/0212361 A1
(43) Pub. Date: Sep. 1, 2011

(54) CELL PACKAGING MATERIAL AND METHOD FOR PRODUCING THE SAME

(75) Inventors: Young-Hee Kim, Gyeonggi-do (KR); Han Jun Kang, Gyeonggi-do (KR); Hee Sik Han, Gyeonggi-do (KR); Jong Woon Yoon, Gyeonggi-do (KR)

(73) Assignee: YOULCHON CHEMICAL CO., LTD., Seoul (KR)

(21) Appl. No.: 13/127,109

(22) PCT Filed: Nov. 3, 2009
(86) PCT No.: PCT/KR09/06408

§ 371 Date: May 2, 2011

(30) Foreign Application Priority Data
Nov. 3, 2008 (KR) 10-2008-0108597

(51) Int. Cl. H01M 2/02; B05D 1/36

(52) U.S. Cl. 429/176; 427/402

(57) ABSTRACT

Provided is a cell packaging material having a layered structure of one or more layers, wherein at least one layer includes a flame retardant, a coating layer imparted with flame resistance, or both. In the cell packaging material, a cell itself does not include any flame resistant film or flame retardant. Therefore, it is possible to provide a cell with flame resistance while not increasing the cell volume or not affecting the cell operation.

### BACKGROUND

1. Field

The present disclosure relates to a cell packaging material and a method for producing the same. More particularly, the present disclosure relates to a cell packaging material useful as an outer packaging material for cells, such as lithium secondary batteries or portable storage batteries, which is provided with flame resistance, as well as to a method for producing the same.

2. Description of the Related Art

In general, various types of batteries (referred to also as “cells” hereinafter) including secondary batteries, such as lithium ion batteries or lithium polymer batteries, or portable storage batteries may undergo a rapid increase in voltage due to internal short circuit, external short circuit or over-charge/discharge, resulting in overheating of cells.

To prevent the above-mentioned problems, the cells may be connected electrically with safety devices, such as positive temperature coefficient (PTC) devices, thermal fuses or protection circuits. Such safety devices interrupt electric current when the cells undergo a rapid increase in voltage or temperature, so as to protect the cells from overheating.

Meanwhile, a cell may be provided in the form of a so-called inner pack battery that includes the cell surrounded with an aluminum material or nickel-plated iron.

In addition, the protective circuit may also be provided with impact resistance by assembling a cell with the protection circuit and then molding the cell together with the protection circuit in a mold.

### SUMMARY

Even when a cell is equipped with a safety device or protective package capable of preventing the cell from damages, the cell still has a problem of explosion or fire due to internal or external factors, including short circuit or overheating of a cell caused by a rapid increase in voltage. Thus, there is a need for providing a cell with flame resistance to minimize or prevent fire accidents resulting from firing of the cell through a self-extinguishing function. The present disclosure is directed to providing a method for providing a cell with flame resistance, while not increasing the cell volume or not affecting the cell operation.

In one aspect, there is provided a cell packaging material having a layered structure of one or more layers, wherein at least one layer includes a flame retardant, a coating layer of flame retardant, or both.

### DETAILED DESCRIPTION

In general, a cell includes a bare cell having a cathode, an anode, a separator, electrolyte, or the like, and the external part of the bare cell may be packed with a packaging material referred to also as a cell packaging material.

In some embodiments of the present disclosure, a flame retardant is incorporated into at least one layer forming the packaging material surrounding the external part of the cell, or a coating layer of flame retardant is formed on at least one of such layers, while not using methods of incorporating a separate flame resistant film into the bare cell or adding a flame retardant to electrolyte. In this manner, it is possible to provide a cell with flame resistance while not affecting the cell volume or cell operation.

In some embodiments, the cell packaging material may include an outermost layer formed of a synthetic resin, a barrier layer formed on the bottom of the outermost layer, and a sealant layer as the innermost layer formed on the bottom of the barrier layer.

An adhesive layer may be formed between the outermost layer and the barrier layer, and a melt extrusion resin layer may be further formed between the barrier layer and the sealant layer.

In some embodiments, a flame retardant may be incorporated into at least one layer selected from the outermost layer, the barrier layer, the melt extrusion resin layer and the sealant layer. In addition, a coating layer of flame retardant may be formed on at least one of the above layers. Further, a flame retardant may be incorporated into at least one of the above layers and a coating layer of flame retardant may be formed on at least one of the above layers.

Such incorporation of a flame retardant may be carried out by adding a flame retardant to the corresponding layer as an additive. Otherwise, when the corresponding layer includes a plastic resin, such incorporation may be carried out by bonding a flame retardant chemically into the plastic resin structure.

In addition, when carrying out such incorporation, a flame retardant may be incorporated particularly into the melt extrusion resin layer and/or the sealant layer in view of flame resistance.

The sealant layer or the melt extrusion resin layer is generally formed of a synthetic resin and exists at the inner part of the cell packaging material. Thus, incorporation of a flame retardant into such layers is favorable in view of flame resistance. In addition, incorporation of a flame retardant into such layers may interrupt combustion from the side of the bare cell. Moreover, it is possible to save the manufacturing cost because there is no additional coating or lamination operation.

When forming a coating layer of flame retardant, the coating layer may be formed particularly on the outermost layer in view of flame resistance. The outermost layer is generally formed of a synthetic resin and exists at the outermost part. The coating layer of flame retardant formed on the outermost layer may interrupt combustion from the external part.

For example, the coating layer of flame retardant may be formed by providing a composition for flame retardant coating and applying the same.

A Non-limiting example of the composition for flame retardant coating includes a binder, a flame retardant, a slip agent and a solvent.

The binder may serve to increase the adhesion of the coating layer of flame retardant to the outermost layer. Non-limiting examples of the binder include copolymers of alkyl acrylate monomers with functionalized monomers, such as acrylic acid, or urethane-based polymers.

Non-limiting examples of the solvent include organic solvents, such as ethylene alcohol (EA), toluene, methyl ethyl ketone (MEK), etc.

As the flame retardant, any conventional flame retardants may be used with no particular limitation. The flame retardant may be compatible with the resin used in each of the outermost layer, the sealant layer and the melt extrusion resin layer, and may not adversely affect the binding property of each layer. In addition, the flame retardant does not affect the mechanical properties of the finished product, and particularly causes a low degree of fuming and toxic gas generation upon combustion.

Non-limiting examples of the flame retardant that may be used herein include organic flame retardants, such as phosphorus-, halogen- or melamine-based flame retardants, or inorganic flame retardants, such as aluminum hydroxide, antimony-based flame retardants or magnesium hydroxide.

The halogen-based flame retardants generally provide flame resistance by stabilizing radicals generated in a gas phase.

Non-limiting examples of the halogen-based flame retardants include tribromophenoxyethane, tetrabromobisphenol-A (TBBA), octabromodiphenyl ether (OBDPE), brominated epoxy, brominated polycarbonate oligomers, brominated benzyl alkyl ether, brominated benzoate, brominated phthalate, chlorinated paraffin, chlorinated polyethylene, aliphatic chlorine-based flame retardants, or the like.

Considering the environmental problems, non-halogen flame retardants may be used. Particularly, such non-halogen flame retardants may include organic flame retardants, such as phosphorus- or melamine-based flame retardants, and inorganic flame retardants.

The phosphorus-based flame retardants generally provide flame resistance by producing polymetaphosphoric acid via thermal decomposition and forming a protective layer from the polymetaphosphoric acid, or by interrupting oxygen through a carbon film formed by dehydration during the production of polymetaphosphoric acid.

Non-limiting examples of the phosphorus-based flame retardant include red phosphorus, phosphates, such as ammonium phosphate, ammonium polyphosphate, trioctyl phosphate, dimethylmethyl phosphate, trimethylpropane methylphosphonic oligomer, pentaerythritol phosphate, cyclic neopentyl thiophosphoric anhydride, triphenyl phosphate, tricresyl phosphate, tert-butylphenyl diphenyl phosphate, tetraphenyl m-p-phenylene diphosphate, tris(2,4-dibromophenyl) phosphate, N,N′-bis(2-hydroxyethyl)aminomethyl phosphonate, phosphine oxide, phosphine oxide diols, phosphites, phosphonates, triaryl phosphate, alkyldiaryl phosphate, trialkyl phosphate, resorcinol bidiphenyl phosphate (RDP), or the like.

Melamine may function as a flame retardant by forming a stable salt with organic acids or inorganic acids. Such melamine-based flame retardants cause a low degree of fuming and are amenable to biodegradation. Non-limiting examples of the melamine-based compound include melamine cyanurate.

The inorganic compound-based flame retardant may provide flame resistance by being decomposed thermally to liberate non-combustible gases, such as water, carbon dioxide, sulfur dioxide, hydrogen chloride, or the like, and to cause endothermic reaction, so that flammable gases are diluted, oxygen approach is prevented, and cooling and formation of thermal decomposition products is reduced through the endothermic reaction.

Non-limiting examples of the inorganic compound-based flame retardant include aluminum hydroxide, magnesium hydroxide, antimony oxide, tin hydroxide, tin oxide, molybdenum oxide, zirconium compounds, zinc tartrate, guanidine-based compounds, borates, calcium salts, or the like.

When forming a coating layer from the above-described flame retardants, the outermost layer may have an increased frictional coefficient, resulting in degradation of molding characteristics of a finished product. Therefore, a slip agent that is compatible with the flame retardant and does not affect desired flame resistance may be added.

The slip agent migrates to and is applied to the surface during or right after processing, and thus prevents adhesion between one film layer and another film layer and provides surface lubrication of films or sheets.

Any slip agents may be used herein and particular examples thereof include polymers imparting slip property, such as silicone, siloxane, silane and wax. Non-limiting examples of the slip agent include fatty acid amides, such as oleic acid amide or eruic acid amide. A coating layer containing such a slip agent reduces frictional coefficient and shows lubrication activity.

Instead of or in combination with the slip agent, an anti-blocking agent may be used. When using an anti-blocking agent instead of the slip agent, the anti-blocking agent may be used in the same amount as the slip agent. In addition, when using an anti-blocking agent in combination with the slip agent, the total amount of the anti-blocking agent and the slip agent may be the same as the amount of the slip agent used alone.

As the anti-blocking agent, inorganic particles, such as silica, diatomaceous earth, kaolin or talc, may be used. Such inorganic particles incorporated into the corresponding coating layer form a thin space between the two adjacent film layers, thereby preventing adhesion between the film layers.

The composition for flame retardant coating including a binder, a flame retardant and a slip agent may be formed by using, based on 100 parts by weight of the binder, 20-80 parts by weight of the flame retardant and 3-20 parts by weight of the slip agent in view of flame resistance, slip property, transparency and coatability.

Particularly, the composition may include, based on 100 parts by weight of the binder, 30-60 parts by weight of the flame retardant and 7-12 parts by weight of the slip agent, and more particularly, 50-60 parts by weight of the flame retardant and 10-12 parts by weight of the slip agent.

The composition for flame retardant coating including, based on 100 parts by weight of the binder, 20-80 parts by weight of the flame retardant and 3-20 parts by weight of the slip agent may further include 300-2500 parts by weight of a solvent. In addition, the resultant coating composition may have a solid content of 5-40 wt % to maintain a constant coating thickness, coating temperature and coating rate.

Hereinafter, each of the layers forming the cell packaging material will be explained in detail.

As the outermost layer, a polyester film having excellent electrolyte resistance may be used alone, a polyamide film capable of reinforcement of moldability may be used alone, or a stack of the polyester film laminated with the polyamide film (the stacking sequence may be varied) may also be used. Further, a polyester film having both electrolyte resistance and moldability as described hereinafter may be used.

The polyester film has excellent electrolyte resistance, and particular examples of the polyester film that may be used herein include at least one selected from the group consisting of polyethylene terephthalate (PET), polybutylene terephthalate (PBT), polyethylene naphthalate (PEN), polybutylene naphthalate (PBN), copolyester and polycarbonate (PC).

To allow the polyester film to protect the surface of a packaging material, the film may have a thickness of 1.2-25 μm, particularly 1.2-9.0 μm.

The polyamide film may be used to reinforce moldability, and the moldability is required particularly in the case of a molded type pouch. For such a molded type pouch, moldable biaxially oriented polyamide films may be used considering the capacity and size of a battery.

Particular examples of the biaxially oriented polyamide film include at least one selected from the group consisting of nylon 6, nylon 6.6, copolymers of nylon 6 with nylon 6.6, nylon 6.10 and polymetaxylylene adipamide (MXD 6). The polyamide film may have a thickness of 15-50 μm, particularly 15-25 μm.

The polyester film is laminated with the polyamide film, and additionally with the polyamide film by way of the underlying adhesive layer. The adhesive used herein may be a polyurethane adhesive having excellent heat resistance, particularly a two-part urethane-based adhesive. Since a packaged cell causes high temperature due to the heating occurring when the cell is moved, an adhesive having low heat resistance may cause interlayer separation between the polyester film and the polyamide film, and between the polyamide film and the underlying layer. Thus, an adhesive having excellent heat resistance may be required.

The heat resistance of an adhesive is determined by placing laminated or finished films into a dry oven set at a predetermined temperature, removing the films from the oven after a predetermined time, and checking whether any interlayer separation occurs or not. In general, the adhesive that may be used herein causes no interlayer separation even after the lapse of 5 minutes at 150° C. or after the lapse of 10 seconds at 260° C.

When a coating layer of flame retardant is formed on the outermost layer, an additional external corona layer may be used. Such an external corona layer may facilitate formation and maintenance of the coating layer.

The barrier layer is intended to interrupt moisture or gas, and particular examples thereof include aluminum foil.

Further, aluminum foil may contain iron. Such aluminum containing iron has excellent insulation property and reduces generation of pinholes causes by bending of a layered laminate. Particularly, when forming an embossed sheath, such aluminum containing iron may facilitate formation of side walls. When the iron content is less than 0.6 wt %, it is not possible to prevent pinhole generation and to improve embossing moldability. On the other hand, when the iron content is greater than 2.0 wt %, flexibility of aluminum may be degraded and processability may be lowered during the molding of a pouch material from the aluminum foil. In addition, aluminum foil may contain silicon. When the silicon content exceeds 0.9 wt %, the aluminum foil show poor processability during the molding into a pouch although it has improved magnetic property. On the other hand, when the silicon content is less than 0.05 wt %, the resultant product has poor strength and elongation, resulting in degradation of processability during the molding into a pouch.

Therefore, the aluminum foil may include, in particular, 0.05-0.9 wt % of silicon and 0.6-2.0 wt % of iron in view of moldability and processability.

Meanwhile, the aluminum foil may be subjected to non-chromate treatment on either surface or both surfaces thereof in order to prevent corrosion and to improve adhesion strength. Such non-chromate treatment includes forming an acid-resistant coating film by using at least one compound selected from the group consisting of organic compounds, such as titanium-containing resins, zirconium or phosphates, and inorganic/organic composites. Herein, the non-chromate treatment may be carried out on both surfaces of the aluminum foil to increase resistance against salt. In addition to the above treatment, the aluminum foil may be coated with polymer resins, such as acrylic resins, phenolic resins, epoxy resins, fluororesins, or the like.

The outermost layer may be adhered to the barrier layer with the intermediate adhesive layer.

Particular examples of the adhesive may include one-part adhesives including epoxy, phenolic, melamine, polyimide, polyester, polyurethane, polyethylene terephthalate copolymer and polyetherurethane adhesives, or two-part adhesives including a base part and a curing agent part. Particularly, polyurethane adhesives having excellent heat resistance may be used.

Adhesives containing a flame retardant may be used in order to improve flame resistance of the cell packaging material. However, when adding a flame retardant to the adhesive layer, excessive flame retardant may cause degradation of adhesive property, resulting in interlayer separation or whitening. Therefore, addition of a flame retardant to the adhesive layer may be carried out in an amount of greater than 0 wt % and equal to or less than 30 wt % based on the weight of the adhesive.

The sealant layer may be formed with a thickness of 5-120 μm. A melt extrusion layer may be further formed between the barrier layer and the sealant layer. For example, the barrier layer, the melt extrusion resin layer and the sealant layer may be stacked in the order as mentioned.

The melt extrusion resin layer serves to laminate an upper layer with a lower layer by providing adhesive force through the melt extrusion coating film. For example, the melt extrusion resin layer may be formed by carrying out melt extrusion of a polypropylene resin or polyethylene resin to apply a polypropylene resin or polyethylene resin coating film on the barrier layer, and then laminated with the sealant layer.

The coating thickness of the melt extrusion resin layer may be 10-80 μm, particularly 10-40 μm.

As described above, a flame retardant may be added to the melt extrusion resin layer to impart flame resistance. The flame retardant may be used in an amount of 0.1-30 wt % based on the weight of the melt extrusion resin. The flame retardant content may be limited so that the adhesion required for the melt extrusion resin layer may not be degraded.

The sealant layer uses a heat sealable resin layer to perform heat sealing of the packaging material.

The resin that may be used herein provides slidability against the mold surface in a molding system and heat sealing strength, and prevents cracking, whitening or pinhole generation of a heat sealing layer caused by molding conditions.

The sealant layer that may be used herein includes plastic films formed by adding at least one selected from ethylene, butadiene and ethylene propylene rubber to at least one selected from polyethylene, polypropylene, ethylene copolymers and propylene copolymers. Further the sealant layer may be a modified polypropylene film.

In addition, terpolymers that are ternary copolymers of ethylene, propylene and butadiene, homopropylene, ethylene copolymers or propylene copolymers may be used as the sealant layer. When using such terpolymers, there is an advantage in that they have a low melting point and enable sealing even under heating at a low temperature of 140° C. or lower.

Considering the above, the innermost sealing surface of the sealant layer uses terpolymers due to such a low melting temperature. However, when the sealant layer has a multi-layer laminated structure having at least two layers, for example, three layers, the layers other than the sealing surface may use not only such terpolymers but also other polymers, such as homopropylene, random copolymers of propylene with ethylene and polypropylene random copolymers.

As described above, a flame retardant may be added to the sealant layer to impart flame resistance. The flame retardant may be added in an amount of 0.1-20 wt % based on the weight of the resin of the sealant layer. The amount of the flame retardant may be limited so that the sealing strength of the sealant layer may not be degraded.

### EXAMPLES

The examples (and experiments) will now be described. The following examples (and experiments) are for illustrative purposes only and not intended to limit the scope of the present disclosure.

### Test Example 1

In the following Examples, the flame resistance-imparted coating layer is formed by applying a composition for flame retardant coating, including 90 parts by weight of a binder (a copolymer of an alkyl acrylate monomer with an acrylic acid functional group-containing monomer), 10 parts by weight of a phosphorus-based flame retardant (dimethylmethyl phosphate), 1 part by weight of a slip agent (fatty acid amide) and 800 parts by weight of toluene as a solvent, onto the outermost layer.

In the following Examples, the melt extrusion resin of a melt extrusion resin layer includes polypropylene and a melt extrusion resin layer containing a flame retardant added thereto is formed by adding a phosphorus-based flame retardant (dimethylmethyl phosphate) to polypropylene as a melt extrusion resin in an amount of 10 wt % based on polypropylene.

In the following Examples, the sealant layer includes a terpolymer of ethylene, propylene and butadiene, and the sealant layer containing a flame retardant added thereto is formed by adding a phosphorus-based flame retardant (dimethylmethyl phosphate) to the terpolymer in an amount of 8 wt % based on the terpolymer.

In Examples 1-6 and Comparative Example 1, the packaging materials for secondary batteries are provided to have the structures as described hereinafter.

### Example 1

Flame resistance-imparted coating layer/outermost layer (nylon layer and PET layer)/adhesive layer/barrier layer (aluminum layer)/melt extrusion resin layer/sealant layer

### Example 2

Flame resistance-imparted coating layer/outermost layer (nylon layer and PET layer)/adhesive layer/barrier layer (aluminum layer)/flame retardant-added melt extrusion resin layer/sealant layer

### Example 3

Flame resistance-imparted coating layer/outermost layer (nylon layer and PET layer)/adhesive layer/barrier layer (aluminum layer)/melt extrusion resin layer/flame retardant-added sealant layer

### Example 4

Flame resistance-imparted coating layer/outermost layer (nylon layer and PET layer)/adhesive layer/barrier layer (aluminum layer)/flame retardant-added melt extrusion resin layer/flame retardant-added sealant layer

### Example 5

Outermost layer (nylon layer and PET layer)/adhesive layer/barrier layer (aluminum layer)/melt extrusion resin layer/flame retardant-added sealant layer

### Example 6

Outermost layer (nylon layer and PET layer)/adhesive layer/barrier layer (aluminum layer)/flame retardant-added melt extrusion resin layer/flame retardant-added sealant layer

### Comparative Example 6

Outermost layer (nylon layer and PET layer)/adhesive layer/barrier layer (aluminum layer)/melt extrusion resin layer/sealant layer

Flame Resistance Test

The flame resistance test is carried out as follows.

(1) Sample size: a sample is cut with a length of 5 in. (127 mm) and a width of 0.5 in. (12.7 mm).

(2) Pretreatment: the sample is left at 23±2° C. under a relative humidity of 50±5% for 48 hours before the test.

(3) Five samples are required for the test.

(4) Each sample is provided and fired by using a burner for 10 seconds. Then, the burner is removed and the time required for fire extinguishment after the sample starts burning (i.e. burning time of the sample) is measured. Five samples are subjected to the same test. Herein, it is noted that the absorbent cotton positioned about 30 cm below the sample is protected from burning caused by sparks falling down during the combustion.

(5) Test results are evaluated as follows: O (extinguished after 10 seconds or less), Δ(extinguished after a time less than 20 seconds), X (extinguished after a time of 20 seconds or more)

After subjecting the Examples 1-6 and Comparative Example 1 to the test, the test results as described hereinafter are obtained.

TABLE 1

| | Flame resistance test | Time (s) |
|---|---|---|
| Example 1 | Δ | 18 |
| Example 2 | ◯ | 7 |
| Example 3 | ◯ | 8 |
| Example 4 | ◯ | 4 |
| Example 5 | Δ | 18 |
| Example 6 | Δ | 16 |
| Comparative Example 1 | X | 25 |

As can be seen from the above, Example 1 having a coating layer of flame retardant, and Examples 5 and 6 having a sealant layer or melt extrusion resin layer containing a flame retardant added thereto show improved flame resistance as compared to Comparative Example 1. Meanwhile, use of a coating layer of flame retardant in combination with a sealant layer or melt extrusion resin layer containing a flame retardant added thereto (Examples 2, 3 and 4) show more improved flame resistance.

Seal Strength Test

To the sealant layer of the pouch according to Example 6 (in this case, 8 wt % of a phosphorus-based flame retardant is added based on the weight of terpolymer), the flame retardant is added in the amount varied as shown in the following Table 2. Then, seal strength is measured.

Particularly, the seal strength test is carried out as follows.

(1) A sample having an adequate size (width about 150 mm, length about 100 mm) is provided after being folded in such a manner that the sealant layer is in contact with itself.

(2) A heat adhesion system is set at a temperature (180° C.), pressure (30 kgf) and time (3.0 sec) used for the test, and is stabilized for about 15 minutes so that the temperature of the seal bars is stabilized.

(3) The sample is placed between the seal bars of the temperature-stabilized heat adhesion system to carry out sealing.

(4) After the completion of the sealing, the sample is cut into a desired size (15 mm) by using a cutter bar.

(5) The cut sample is determined for its heat adhesion strength, after the full scale of a tensile strength tester is set at a value of strength 20-50% higher than the predicted value of the heat seal strength of the sample.

(6) A seal strength of 3 kgf/15 mm or higher is satisfactory.

TABLE 2

| | Amount of flame retardant | | | | | |
|---|---|---|---|---|---|---|
| | 0.1 wt % | 1 wt % | 5 wt % | 10 wt % | 20 wt % | 21 wt % |
| Seal | 5.5 | 5.5 | 5.0 | 5.0 | 3.2 | 2.4 |
| strength* | | | | | | |

*expressed in the unit of kgf/15 mm

As can be seen from Table 2, when the flame retardant is used in an amount of 10 wt % or less, it is possible to obtain seal strength as high as 5.0 kgf/15 mm or more. When the flame retardant is used in an amount greater than 20 wt %, seal strength is lowered.

Interlayer Delamination Test

To the melt extrusion resin layer of the pouch according to Example 6 (in this case, 10 wt % of a phosphorus-based flame retardant is added based on the weight of polypropylene), the flame retardant is added in the amount varied as shown in the following Table 3. Then, an interlayer delamination test is carried out between the barrier layer and the melt extrusion resin layer.

Particularly, the interlayer delamination test is carried out as follows.

(1) The cell pouch is cut into a size of width (15 mm)×length (150 mm) by using a cutter bar to provide a sample.

(2) The barrier layer and the melt extrusion resin layer cut into a predetermined size are subjected to interlayer delamination over a predetermined length by using a razor.

(3) The sample subjected to interlayer delamination in a predetermined portion is dipped into a container in which standard electrolyte is received, followed by sealing. Particularly, the electrolyte has the composition of EC:DEC:DMC=1:1:1, LiPF₆ 1M.

(4) The electrolyte container having the sample received therein is stored in a dry oven at 85° C. for 1 day.

(5) After 1 day, the sample is removed and determined for its interlayer delamination strength.

(6) The cut sample is determined for its delamination strength, after the full scale of a tensile strength tester is set at a value of strength 20-50% higher than the predicted value of the heat seal strength of the sample.

(7) A strength of 0.5 kgf/15 mm or higher is satisfactory.

TABLE 3

| | Amount of flame retardant | | | | | | |
|---|---|---|---|---|---|---|---|
| | 0.1 wt % | 1 wt % | 5 wt % | 10 wt % | 15 wt % | 30 wt % | 31 wt % |
| Initial interlayer | 1.2 kgf | 1.2 kgf | 1.2 kgf | 1.2 kgf | 1.2 kgf | 1.2 kgf | 1.2 kgf |
| delamination strength | | | | | | | |
| Interlayer | 1.2 kgf | 1.0 kgf | 1.0 kgf | 1.0 kgf | 0.83 kgf | 0.56 kgf | 0.4 kgf |
| delamination strength | | | | | | | |
| after 1 day | | | | | | | |

As can be seen from Table 3, when the flame retardant is used in an amount of 15 wt % or less, it is possible to obtain interlayer delamination strength of 0.83 kgf/15 mm or more, nearly about 1 kgf/15 mm, even after 1 day. When the flame retardant is used in an amount greater than 15 wt %, interlayer delamination strength is lowered continuously.

### Test Example 2

This EXAMPLE is provided to test the flame resistance, slip property, transparency and coatability of a sample depending on the mixing ratio of a composition for flame retardant coating.

Films are provided in the same manner as described in TEST EXAMPLE 1, except that the three components other than solvent forming the coating composition used for the coating layer on the outermost layer are mixed in the ratio as shown in the following Table 4.

TABLE 4

| | Mixing ratio (weight ratio) |
|---|---|
| | Binder:Flame retardant:Slip agent |
| Example 1 | 9:0.9:0.1 |
| Example 2 | 8:1.7:0.3 |
| Example 3 | 7:2.5:0.5 |
| Example 4 | 6:3.3:0.7 |
| Example 5 | 5:4:1 |
| Example 6 | 3:5:2 |

Determination of Slip Property

Slip property of a sample is tested as follows.

(1) The sample is cut along the machine direction while it is not contaminated and wrinkled.

(2) Fifteen samples are cut into a size of 120 mm×250 mm.

(3) Fifteen samples are cut into a size of 75 mm×100 mm.

(4) The sample with a size of 120 mm×250 mm are fixed on a plane that moves in the horizontal direction with a predetermined surface (coated surface) is positioned as the top surface.

(5) The sample with a size of 75 mm×100 mm is placed thereon until it reaches a predetermined position (the testing wire may not be drawn at the position; the predetermined position is shown by a line), and then 200 g of SLED is further placed thereon by applying it mildly (without applying impact).

(6) The frictional coefficient is measured and the test results are evaluated as follows: X (dynamic frictional coefficient of 0.3 or higher); Δ (dynamic frictional coefficient of 0.2-0.3); and O (dynamic frictional coefficient of 0.2 or less).

Flame Resistance Test: the Same Flame Resistance Test as Described in Test Example 1 is Carried Out.

Transparency Test

A transparency test is carried out as follows.

(1) A sample is cut into a size of 25 mm×25 mm.

(2) The sample is placed and retained in such a manner that a predetermined surface faces to a predetermined direction.

(3) The values as expressed by the following formulae are measured five times and the results are shown as the average value:

Total light transmittance (Tt, %)=quantity of total transmitted light (T2)/quantity of total incident light (T1)×100

Diffused transmittance (Td, %)=T2={(quantity of light diffused by the system and sample, T4)−[(quantity of light diffused by the system, T3)×(quantity of total incident light, T1)]}/(quantity of total incident light, T1)×100

(4) The transparency test results are evaluated as follows: X (20 or higher), Δ (10 or higher), O (10 or lower)

Coatability Test

A coatability test is carried out as follows.

(1) Cotton swab is provided by surrounding the tip of a stick (diameter about 1 mm, length about 10 cm) with absorbent cotton.

(2) The cotton swab is wet with a corona solution to such a degree that no liquid drops fall down from the tip, is positioned to be parallel with the sample, and is moved straightly so that the solution is applied to the sample.

(3) When the sample is still wet at least 2 seconds after applying the corona solution, the sample is evaluated as ‘wet’. When such a wet state is maintained for 2 seconds or more, a reagent having a higher surface tension than the solution is used to check whether the sample is wet or not. The test is performed sequentially by using standard solutions having gradually increasing surface tensions.

(4) The test is carried out over the whole part of the sample, and along the transverse direction and longitudinal direction. The results are shown as averaged wetting indexes.

(5) The corona solution includes formamide and ethylene glycol monomethyl ether.

(6) The coating test results are evaluated as follows: X (non-coatable; 35 dynes or less), Δ (insufficient coatability; 36-37 dynes), O (good coatability; 38 dynes or more).

The test results are shown in the following Table 5.

TABLE 5

| | Slip | Flame | | |
|---|---|---|---|---|
| | property | resistance | Transparency | Coatability |
| Example 1 | X | X | ◯ | ◯ |
| Example 2 | Δ | Δ | ◯ | ◯ |
| Example 3 | ◯ | Δ | ◯ | ◯ |
| Example 4 | ◯ | ◯ | ◯ | ◯ |
| Example 5 | ◯ | ◯ | Δ | Δ |
| Example 6 | ◯ | ◯ | X | X |

As can be seen from the above results, Examples 1 and 2 show relatively low slip property and flame resistance, and Examples 5 and 6 show relatively low transparency and coatability. Examples 2, 3, 4 and 5 provide good and at least satisfactory results in terms of slip property, flame resistance, transparency and coatability.

It can be seen clearly from the above that the cell packaging material provided with flame resistance in accordance with the method as disclosed herein is useful as an outer packaging material for cells, such as lithium secondary batteries or portable storage batteries.

According to some embodiments of the present disclosure, a cell itself does not include any flame resistant film or flame retardant. Therefore, it is possible to provide a cell with flame resistance while not increasing the cell volume or not affecting the cell operation.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

1. A cell packaging material having a layered structure of one or more layers, wherein at least one layer comprises a flame retardant, a coating layer of flame retardant, or both.

2. The cell packaging material according to claim 1, which comprises an outermost layer formed of a synthetic resin, and the coating layer of flame retardant is formed on the outermost layer.

3. The cell packaging material according to claim 1, which comprises a sealant layer as an innermost layer and a melt extrusion resin layer formed on the sealant layer, wherein the flame retardant is incorporated into at least one of the sealant layer and the melt extrusion resin layer.

4. A cell packaging material comprising: an outermost layer formed of a synthetic resin; a barrier layer formed on the bottom of the outermost layer; a melt extrusion resin layer formed on the bottom of the barrier layer; and a sealant layer formed on the bottom of the melt extrusion resin layer,
wherein a flame retardant is incorporated into at least one of the outermost layer, the barrier layer, the melt extrusion resin layer and the sealant layer, a coating layer of flame retardant is formed on at least one of the outermost layer, the barrier layer, the melt extrusion resin layer and the sealant layer, or a flame retardant is incorporated into and a coating layer of flame retardant is formed on at least one of the outermost layer, the barrier layer, the melt extrusion resin layer and the sealant layer.

5. A cell packaging material comprising: an outermost layer formed of a synthetic resin; a barrier layer formed on the bottom of the outermost layer; a melt extrusion resin layer formed on the bottom of the barrier layer; and a sealant layer formed on the bottom of the melt extrusion resin layer,
wherein a coating layer of flame retardant is formed on the outermost layer, and a flame retardant is incorporated into at least one of the sealant layer and the melt extrusion resin layer.

6. The cell packaging material according to claim 4, a surface corona layer is further formed between the outermost layer and the coating layer of flame retardant.

7. The cell packaging material according to claim 1, wherein the coating layer of flame retardant comprises a flame retardant coating composition comprising: based on 100 parts by weight of a binder, 20-80 parts by weight of a flame retardant and 3-20 parts by weight of a slip agent.

8. The cell packaging material according to claim 4, wherein an adhesive layer is further formed between the outermost layer and the barrier layer, and the adhesive layer comprises the flame retardant in an amount of more than 0 wt % and equal to or less than 30 wt % based on the weight of the resin of the adhesive layer.

9. The cell packaging material according to claim 4, wherein the flame retardant is used in the sealant layer in an amount of 0.1-20 wt % based on the weight of the resin of the sealant layer.

10. The cell packaging material according to claim 9, wherein the sealant layer comprises a terpolymer of ethylene, propylene and butadiene.

11. The cell packaging material according to claim 4, wherein the flame retardant is used in the melt extrusion resin layer in an amount of 0.1-30 wt % based on the weight of the resin of the melt extrusion resin layer.

12. The cell packaging material according to claim 1, wherein the flame retardant is at least one selected from the group consisting of halogen-based flame retardants, phosphorus-based flame retardants, melamine-based flame retardants and inorganic flame retardants.

13. A method for producing a cell packaging material, comprising incorporating a flame retardant into at least one layer forming the cell packaging material, forming a coating layer of flame retardant on at least one layer forming the cell packaging material, or both.

14. The method for producing a cell packaging material according to claim 13, which comprises:
forming a coating layer of flame retardant on an outermost layer formed of a synthetic resin; and
incorporating a flame retardant into at least one of a sealant layer as an innermost layer and a melt extrusion resin layer formed on the sealant layer.

15. The cell packaging material according to claim 2, which comprises a sealant layer as an innermost layer and a melt extrusion resin layer formed on the sealant layer, wherein the flame retardant is incorporated into at least one of the sealant layer and the melt extrusion resin layer.

16. The cell packaging material according to claim 5, a surface corona layer is further formed between the outermost layer and the coating layer of flame retardant.

17. The cell packaging material according to claim 2, wherein the coating layer of flame retardant comprises a flame retardant coating composition comprising: based on 100 parts by weight of a binder, 20-80 parts by weight of a flame retardant and 3-20 parts by weight of a slip agent.

18. The cell packaging material according to claim 4, wherein the coating layer of flame retardant comprises a flame retardant coating composition comprising: based on 100 parts by weight of a binder, 20-80 parts by weight of a flame retardant and 3-20 parts by weight of a slip agent.

19. The cell packaging material according to claim 5, wherein the coating layer of flame retardant comprises a flame retardant coating composition comprising: based on 100 parts by weight of a binder, 20-80 parts by weight of a flame retardant and 3-20 parts by weight of a slip agent.

20. The cell packaging material according to claim 5, wherein an adhesive layer is further formed between the outermost layer and the barrier layer, and the adhesive layer comprises the flame retardant in an amount of more than 0 wt % and equal to or less than 30 wt % based on the weight of the resin of the adhesive layer.

21. The cell packaging material according to claim 5, wherein the flame retardant is used in the sealant layer in an amount of 0.1-20 wt % based on the weight of the resin of the sealant layer.

22. The cell packaging material according to claim 21, wherein the sealant layer comprises a terpolymer of ethylene, propylene and butadiene.

23. The cell packaging material according to claim 5, wherein the flame retardant is used in the melt extrusion resin layer in an amount of 0.1-30 wt % based on the weight of the resin of the melt extrusion resin layer.

24. The cell packaging material according to 2, wherein the flame retardant is at least one selected from the group consisting of halogen-based flame retardants, phosphorus-based flame retardants, melamine-based flame retardants and inorganic flame retardants.

25. The cell packaging material according to claim 4, wherein the flame retardant is at least one selected from the group consisting of halogen-based flame retardants, phosphorus-based flame retardants, melamine-based flame retardants and inorganic flame retardants.

26. The cell packaging material according to claim 5, wherein the flame retardant is at least one selected from the group consisting of halogen-based flame retardants, phosphorus-based flame retardants, melamine-based flame retardants and inorganic flame retardants.
